(19) United States
(12) Patent Application Publication
(10) Pub. No.: US 2024/0267153 A1
(43) Pub. Date: Aug. 8, 2024

(54) Dynamic Error Correction For Data Transmissions

(71) Applicant: QUALCOMM Incorporated, San Diego, CA (US)

(72) Inventors: Hussein METWALY SAAD, San Diego, CA (US); Sanket Sanjay KALAMKAR, San Diego, CA (US); Peerapol TINNAKORNSRISUPHAP, San Diego, CA (US); Simone MERLIN, San Diego, CA (US); Sebastien MOUNIER, San Diego, CA (US); Vinesh DHANARAJ, San Diego, CA (US); Amira ALLOUM, Boulogne Billancourt (FR); Yih-Hao LIN, San Diego, CA (US); Ravi AGARWAL, San Diego, CA (US); Ovidiu Constantin IACOBOAIEA, Chatillon (FR)

(21) Appl. No.: 18/164,914

(22) Filed: Feb. 6, 2023

(51) Int. Cl. H04L 1/00; H04W 72/541; H04W 72/542

(52) U.S. Cl. CPC H04L 1/0041; H04W 72/541; H04W 72/542

(57) ABSTRACT

Embodiments of systems and methods for dynamic error correction for data transmissions may include determining parameters of a wireless communication link by which a user equipment (UE) receives data that is transmitted from a remote computing device via a wireless communication network and that is used by an application executing in the UE, receiving sensor information from sensors of the UE, predicting a condition of the wireless communication link based on the determined parameters of the wireless communication link and the received sensor information, and selecting a forward error correction (FEC) rate for communications with the remote computing device based on the predicted condition of the wireless communication link.

### BACKGROUND

Long Term Evolution (LTE), Fifth Generation (5G) New Radio (NR), and other communication technologies enable improved communication and data services. One such service is data streaming, which may be used to support a variety of applications, such as multimedia applications, online gaming, voice and video conferencing, and other suitable applications. User equipment (UE) may receive streamed data over a wireless communication link for use by such an application. The radio frequency (RF) environment of the UE may change because of UE mobility. If the RF environment rapidly degrades, uplink and/or downlink packet loss may trigger retransmission of data packets, increasing streamed data latency to the application. Such data latency may cause application performance to degrade if application data requirement(s) are not met.

### SUMMARY

Various aspects include systems and methods performed by a user equipment (UE) for dynamic error correction for data transmission. In some embodiments, the methods performed by the UE may include determining parameters of a wireless communication link by which the UE receives data that is transmitted from a remote computing device via a wireless communication network and that is used by an application executing in the UE, receiving sensor information from sensors of the UE, predicting a condition of the wireless communication link based on the determined parameters of the wireless communication link and the received sensor information, and selecting a forward error correction (FEC) rate for communications with the remote computing device based on the predicted condition of the wireless communication link.

In some aspects, receiving sensor information from the application executing on the UE may include receiving pose information from a sensor of an extended reality (XR) device. In some aspects, predicting the condition of the wireless communication link based on the determined parameters of the wireless communication link and the received sensor information may include predicting a change in radio frequency (RF) conditions based on the determined parameters of the wireless communication link and the received sensor information. Some aspects may include transmitting the selected FEC rate to the remote computing device in a manner that enables the remote computing device to use the selected FEC rate in data transmissions to the UE.

Some aspects may include using the selected FEC rate in data transmissions from the UE to the remote computing device. In some aspects, predicting the condition of the wireless communication link may include predicting a block error rate (BLER) of data received from the remote computing device. In some aspects, predicting the condition of the wireless communication link may include predicting a transport block (TB) size of data received from the remote computing device.

Further aspects include a UE having a processor configured to perform one or more operations of any of the methods summarized above. Further aspects include processing devices for use in a UE configured with processor-executable instructions to perform operations of any of the methods summarized above. Further aspects include a non-transitory processor-readable storage medium having stored thereon processor-executable instructions configured to cause a processor of a UE to perform operations of any of the methods summarized above. Further aspects include a UE having means for performing functions of any of the methods summarized above. Further aspects include a system on chip for use in a UE and that includes a processor configured to perform one or more operations of any of the methods summarized above.

Various aspects include systems and methods performed by a computing device (such as a network computing device) for dynamic error correction for data transmission. In some embodiments, the methods performed by the computing device may include receiving from a UE a prediction of a condition of a wireless communication link by which the UE receives data transmitted by the computing device, selecting an FEC rate for data transmissions to the UE based on the received prediction of the condition of the wireless communication link, and using the selected FEC rate in data transmissions to the UE.

Some aspects may include receiving from a user equipment (UE) a prediction of a condition of a wireless communication link by which the UE receives data transmitted by the computing device, selecting a forward error correction (FEC) rate for data transmissions to the UE based on the received prediction of the condition of the wireless communication link, and using the selected FEC rate in data transmissions to the UE. In some aspects, receiving from the UE the prediction of the condition of the wireless communication link by which the UE receives data transmitted by the computing device may include receiving a prediction of UE pose information, and selecting the FEC rate for data transmissions to the UE based on the received prediction of the condition of the wireless communication link may include selecting the FEC rate based on the prediction of UE pose information.

Some aspects may include determining a type of data to be transmitted to the UE, wherein selecting the FEC rate for data transmissions to the UE is further based on the type of data to be transmitted to the UE. Some aspects may include determining a data latency requirement of an application executing on the UE that uses data transmitted by the computing device, wherein selecting the FEC rate for data transmissions to the UE is further based on the data latency requirement of the application executing on the UE. Some aspects may include identifying a data flow from among data being transmitted to the UE that will not meet a data latency requirement of the application executing on the UE, wherein using the selected FEC rate in data transmissions to the UE may include using the selected FEC rate in transmissions of the identified data flow to the UE.

Further aspects include a network computing device having a processor configured to perform one or more operations of any of the methods summarized above. Further aspects include processing devices for use in a network computing device configured with processor-executable instructions to perform operations of any of the methods summarized above. Further aspects include a non-transitory processor-readable storage medium having stored thereon processor-executable instructions configured to cause a processor of a network computing device to perform operations of any of the methods summarized above. Further aspects include a network computing device having means for performing functions of any of the methods summarized above. Further aspects include a system on chip for use in a network computing device and that includes a processor configured to perform one or more operations of any of the methods summarized above.

### BRIEF DESCRIPTION OF THE DRAWINGS

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4A is a block diagram illustrating an example system architecture suitable for implementing any of the various embodiments.

FIG. 4B is a block diagram illustrating an example system architecture suitable for implementing any of the various embodiments.

FIG. 5 is a process flow diagram illustrating a method that may be performed by a processor of a UE for dynamic error correction for data transmissions in accordance with various embodiments.

FIG. 6A is a process flow diagram illustrating a method that may be performed by a processor of a computing device for dynamic error correction for data transmissions in accordance with various embodiments.

FIGS. 6B-6D are process flow diagrams illustrating operations that may be performed by a processor of a computing device as part of the method for dynamic error correction for data transmissions in accordance with various embodiments.

FIG. 7 is a component block diagram of a UE suitable for use with various embodiments.

FIG. 8 is a component block diagram of a network device suitable for use with various embodiments.

FIG. 9 is a component block diagram of a UE suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments enable a UE and a network computing device, such as a server, to increase the efficiency of streaming data packet communications by adjusting forward error correction (FEC) parameters in anticipation of changes in conditions of a wireless communication link due to movements of the UE, as well as potentially other information, detected or determined based on sensor information received from one or more sensors of the UE. Various embodiments improve the operation and performance of streaming data and services and applications that use the streaming data by predicting when the RF environment of the UE will change and proactively adjusting FEC parameters accordingly. As a non-limiting example, various embodiments may be implemented in a wireless extended reality (XR) headset UE to adjust FEC parameters in response to sensed movements of the user's head (up, down, left, right, etc.) to accommodate resulting changes in a wireless communication link over which XR images are received.

The term “user equipment” (UE) is used herein to refer to any one or all of wireless communication devices, XR headsets, augmented reality (AR) devices, extended reality (ER) devices, smartphones, portable computing devices, personal or mobile multi-media players, laptop computers, tablet computers, multimedia Internet-enabled cellular telephones, medical devices and equipment, entertainment devices (for example, wireless gaming controllers, music and video players, satellite radios, etc.), wireless communication elements within vehicles, wireless devices affixed to or incorporated into various mobile platforms, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for Global System for Mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Streaming data applications, such as XR application, which is used herein to refer generally to virtual reality (VR), augmented reality (AR), mixed reality (MR), and the like applications, network-based game applications (“cloud” gaming applications), and other similar applications that use data conveyed by a communication network, typically should receive streaming data with high reliability, high bandwidth, and low latency to satisfy one or more performance or data rate requirements to achieve a satisfactory user experience. Such applications are sometimes referred to as “latency sensitive” applications. Some latency sensitive applications require low latency data communication in both an uplink direction Anna downlink direction. For example, in some applications, XR or cloud gaming downlink traffic may be quasi-periodic with burst every frame at 1 frame per second (e.g., 90 Hz). Such uplink traffic can include information about the controller, the user pose, hand tracking, accessories, back-channel audio, and user video. An uplink traffic frequency may be at, for example, 90 Hz or 120 Hz, which may match a display rate of data received in the downlink. Such uplink data traffic may be transmitted over a wireless communication link (air interface) to a base station (e.g., a gNB) which may transmit the data to an Edge server or another network computing device which may render audio and/or video packets for transmission to the UE and the downlink based on, for example, information such as controller or user pose data.

For latency sensitive applications, prediction of or fast adaptation to changes in RF conditions may be important for providing sufficient data to the application to enable the application to meet one or more performance requirements or data requirements for satisfactory user experiences. This may be especially true in communications systems that use millimeter wave (mmW) and higher frequencies, in which the channel and propagation characteristics are very sensitive to user position and orientation changes and/or RF environment changes. For example, intervening structures or RF interference may have a dramatic effect on such wireless communication links. As another example, changes in user pose or the pose of a UE may interfere with or block RF signals. For example, an XR headset, VR goggles, or similar devices may experience rapid changes a wireless communication link to a wireless hub (e.g., a smartphone or computer Bluetooth® antenna, Wi-Fi access point, cellular base station, etc.) in response to changes in the up, down, left, right orientation (referred to generally as “pose”) of the wearer's head. Higher frequency wireless communication links (e.g., mmW or higher) in particular may be degraded by intervening structures, including a user's head or other body part. If the wireless communication link is degraded, bit error rates in uplink and/or downlink packets may lead to packet loss requiring retransmission of data packets impacting data latency until increases in FEC information is included in data packet transmissions. On the other hand, including more FEC information in data packet transmissions than required to ensure reliable data reception may unnecessarily reduce the data transmission rate, which can also degrade the user experience. Thus, dynamically adjusting the level of FEC information included in data packet transmissions is important for improving the user experience.

FEC coding and information may include information regarding the data in the data packet, redundant data and other encoded information that enables a receiving device to detect and correct at least some transmission errors, thus eliminating the need for retransmission of a data packet that includes some erroneous bits. Increasing FEC information in data packet transmission enables a receiver (e.g., UE) to recover data in received packets in spite of degraded link conditions. Recovering data using FEC techniques can decrease the rate of packet retransmissions, such as from Hybrid Automatic Repeat Request (HARQ) or Radio Link Control (RLC) retransmission mechanisms. In some systems, the receiving application (i.e., a latency sensitive application) may control an amount of FEC applied to an uplink transmission, and/or may send signaling to control or request an amount of FEC applied to downlink transmissions. Including FEC data in either or both of the uplink or downlink may decrease an amount of streaming data included per unit of data transmitted. However, convention FEC processes are typically applied statically, and are triggered in reaction to a detected condition.

Conventional wireless communication systems adjust FEC coding and information used in wireless data transmissions in a reactive manner based on changes in a wireless communication link, such as increases or decreases in bit error rates, pack loss, etc. However, reactively adjusting FEC information in data transmissions requires the receiver to detect, and in some implementations report to the transmitter, changes in the communication link based on increases or decreases in packet loss. Thus, when communication link conditions degrade, several packets may be lost, requiring retransmission and the attendant increase in latency, before the transmitter is able to adjust the FEC information in transmitted packets. Similarly, when communication link conditions improve, it may take the transmitter a relatively long time (e.g., transmission of hundreds or thousands of packets) to recognize this and reduce the amount of FEC information in data packet transmissions, thus unnecessarily reducing the data transmission rate for that duration. In implementations in which changes in the communication link can happen frequently, such as in the case of an XR headset due to user movements, the delays in adjusting FEC information in data packets can impact the user experience.

Various embodiments include systems and methods for proactively adjusting FEC information used in transmissions by predicting changes in link quality based on information such as detected movements, such as a change in pose of an XR headset, and adjusting the FEC information used in data transmissions in response to the prediction rather than in response to measured degradations or improvements in link quality. Predicting changes in link quality and dynamically adapting the amount of FEC information applied to data transmissions may enable UEs and network computing devices to enable the appropriate level of FEC information in data packets in situations of high UE mobility, such as XR headsets, UEs receiving data at a cell edge, motion near structures that can block wireless signals, communication link handover, and/or the like. For ease of reference, the amount of FEC information (e.g., a percentage of data transmissions, proportion of data transmissions, number bits, type of FEC information, etc.) applied to data transmissions may be referred to herein as an “FEC rate.”

Various embodiments are particularly useful in situations in which a UE (e.g., an XR headset) is receiving streaming data from a remote computing device, such as a server providing XR imagery or streaming video. In various embodiments, the UE may determine parameters of a wireless communication link by which the UE is receiving data transmitted by the remote computing device (e.g., via a wireless communication network). Non-limiting examples of wireless communication link parameters that may be determined include link quality, bit error rates, packet error rates, signal strength, signal to noise ratio, etc.

In various embodiments, the UE may also receive position and/or pose-related sensor information from sensors in or on the UE, including motion and orientation sensors, such as accelerometers, inertial motion sensors, gravitometers, gyroscopes, navigation systems (e.g., Global Positioning System (GPS) receivers) and the like. The UE may also receive information from other types of sensors, including cameras and lidar, that can generate a depth map or similar information regarding objects and distance to object surfaces from the UE, and other sensors, and the like. Position and/or pose-related sensors and other suitable sensors may provide information that can be processed by the UE to predict a near-future orientation and position of the UE relative to an antenna providing a wireless communication link (e.g., of a base station) and to objects that could impact the wireless communication link.

In various embodiments, the UE may use the position and/or pose-related sensor information to predict a near-future (i.e., with the next few seconds) condition of the wireless communication link based on the determined parameters of the wireless communication link and the received sensor information. For example, based on recent and current link quality information and predicted changes in the pose of the UE (e.g., XR headset), the UE may predict that the wireless communication link is about to experience degradation in link conditions or link quality (e.g., increase bit error rate, decreased signal-to-noise ratio, etc.) or improvement in link conditions or link quality (e.g., increase bit error rate, decreased signal-to-noise ratio, etc.).

In various embodiments, the UE may use the predicted near-future condition of the wireless communication link or predicted change in wireless link conditions or quality to select an FEC rate for data communications to the remote computing device and/or inform the remote computing device of the FEC rate (or predicted change in link conditions or quality) for use in using the appropriate FEC rate in data transmissions to the UE. By adjusting the FEC rate used in uplink communications to the remote computing device, the UE can reduce the number of packet retransmissions required to deliver application uplink data. By enabling the remote computing device to include an appropriate FEC rate in download data packets, the number or rate of packet retransmissions can be reduced while avoiding an unnecessary level of FEC information, thereby improving latency and download data rates.

Using the example of an XR headset, predictable but frequent changes in link conditions or quality may occur as the user's head moves up, down, left and right, such as to view various scenes or images. Such movements of the XR headset can be measured by accelerometers and gyroscopes in the headset electronics, enabling changes in pose to be predicted, and based on the predicted pose, enabling changes in wireless link quality to be anticipated. Then by the time the user's head has turned to look at a particular virtual image or scene, the communication links between the XR headset and the remote computing device providing the image or scene data can be using an appropriate FEC rate. Continuously adjusting FEC rates in data packet communications by anticipating changes in link quality based on XR headset movements may thus enhance the user experience by ensuring suitable latency and data transfer rates.

In some embodiments, the UE may use perception information such as RF condition information about a wireless communication link (parameters of the wireless communication link) and sensor information from sensors of the UE. The RF condition information may include signal strength information, signal quality information, and the like. The RF condition information also may include a data rate, a data throughput, a block error rate (BLER), a transport block (TB) size, or another metric of data carriage. The sensor information may include information indicative of the pose of the UE, such as a location of the UE, a rotation of the UE, an orientation of the UE, an acceleration of the UE, and/or the like. Using the perception information, the UE may predict a condition of the wireless communication link. In some embodiments, the UE may predict a condition that may improve an aspect of the wireless communication link. In some embodiments, the UE may predict a condition that may attenuate or block an aspect of the wireless communication link (e.g., an “attenuating condition”).

For example, the UE may determine that one or more parameters of the wireless communication link exceed a threshold, such that the wireless communication link is capable of providing sufficient data to an application (e.g., an XR application) executing on the UE that meets one or more performance thresholds of the application. Based on determined parameters of the wireless communication link and sensor information from the application, the UE may predict that RF conditions are degrading (trending downward) or will degrade (will trend downward) toward an RF condition threshold at which the FEC rate should be adjusted.

In some embodiments, the UE may correlate wireless communication link parameters and sensor information from the UE. In some embodiments, the UE may predict a condition of the wireless communication link based on historical information or other experiential information. In some embodiments, the UE may predict a condition of the wireless communication link based on one or more trends in RF conditions or parameter(s) of the wireless communication link. In some embodiments, the UE may use pose information of the UE (e.g., acceleration, rotation, location information, and/or the like) to predict when the UE will experience a change in the wireless communication link (which may be an improvement or a degradation in the wild communication link).

For example, based on the sensor information, the UE may determine that a sudden decline or drop in RF conditions may be due to signal attenuation (or blocking) caused by a change in UE pose, such as blocking of a signal to an XR headset by a user's head or other body part. As another example, based on the sensor information, the UE may predict that RF conditions will suddenly decline or drop, for example, by determining that the UE is going to be in a location and/or orientation in which RF link quality or RF conditions degraded or were poor (e.g., dropped below and RF threshold) in the past.

In some embodiments, the UE may predict whether RF signals of the communication link will be attenuated or blocked, for example, decreased below and RF signal threshold. In some embodiments, the UE may predict a timing of when such attenuation or blockage will occur. In some embodiments, the UE may predict a duration of such attenuation or blockage. In some embodiments, the UE may predict a rate, direction, and/or duration of motion of the UE. In some embodiments, the UE may predict a BLER of data received from the remote computing device. In some embodiments, the UE may predict a TB size of data received from the remote computing device.

In some embodiments, the UE may learn over time and may predict an impact of changes in UE pose and/or position on various wireless communication link parameters on wireless communication link/RF conditions. For example, the UE may learn an effect of changes in in UE pose and/or position on BLER and/or TB size on wireless communication link conditions. The UE may use such learned effects to predict a condition of the wireless communication link based on determined parameters of the wireless communication link and the position and pose-related sensor information of the UE.

Based on one or more of the predicted conditions of the wireless communication link, the UE may select an FEC rate for communications with the remote computing device. For example, the UE may select a higher FEC rate, or may increase an FEC rate, corresponding to an increasing or large TB size. In part, this may be due to more IP packets being lost with a larger TB size than with a smaller TB size. As another example, the UE may select a higher FEC rate or may increase an FEC rate in response to predicting a larger or increased BLER. As another example, the UE may select a lower FEC rate or may decrease the FEC rate corresponding to a decreasing or small TB size, or in response to predicting a smaller or decreased BLER.

In some embodiments, the UE may transmit the selected FEC rate to the remote computing device in a manner that enables the remote computing device to use the selected FEC rate in data transmissions to the UE. In some embodiments, the UE may transmit information regarding the predicted change in wireless link quality to the remote computing device in a manner that enables the remote computing device to determine the appropriate FEC rate to use in data transmissions to the UE. In some embodiments, the UE may use the selected FEC rate in data transmissions from the UE to the remote computing device.

In some embodiments, a network computing device may receive from the UE a prediction of a condition of a wireless communication link by which the UE receives data transmitted by the computing device. The network computing device may select an FEC rate for data transmissions to the UE based on the received prediction of the condition of the wireless communication link, and may use the selected FEC rate in data transmissions to the UE.

In some embodiments, the network computing device may receive from the UE a prediction of UE pose information. For example, the network computing device may receive a prediction of one or more of an acceleration, a rotation, location information, and/or the like of the UE. Based on the prediction of the UE pose information, the network computing device may select the FEC rate for data transmissions to the UE. In some embodiments, the network computing device may determine a type of data to be transmitted to the UE, and may select the FEC rate for data transmissions to the UE based on the type of data to be transmitted to the UE as well as the UE pose information. For example, the UE may determine whether data to be transmitted to the UE includes audio data, image data, video data, multimedia data, and/or the like.

In some embodiments, the network computing device may determine a data latency requirement of the application executing on the UE that uses the data transmitted by the network computing device, and select the FEC rate for data transmissions to the UE based on the data latency requirement of the application as well as the UE position and pose-related sensor information.

In some embodiments, the network computing device may selectively apply an FEC rate to one or more data flows from among the data being transmitted to the UE. For example, the network computing device may identify a data flow that will not meet a data latency requirement of the application executing on the UE. In such embodiments, the network computing device may use the selected FEC rate for the identified data flow. In such embodiments, the network computing device may not apply the selected FEC data rate to one or more other data flows transmitted to the UE. In some embodiments, the network computing device may apply the selected FEC data rate to only the identified data flow, but not to any (or all) other data being transmitted to the UE.

Various embodiments improve wireless communications of data for data streaming and applications that use streamed data by enabling UEs and network computing devices to improve proactively adjust FEC rates in data transmissions to reduce data latency and improve overall data transmission rates. Various embodiments improve the operation of UEs and network computing devices by enabling the UEs and/or network computing devices to dynamically determine (select) and apply forward error correction to data transmissions based on predicted changes in wireless communication links. Various embodiments improve the operation of XR devices and applications by enabling UEs and/or network computing devices to dynamically select and apply FEC to data transmissions based on, among other things, pose information of an XR device.

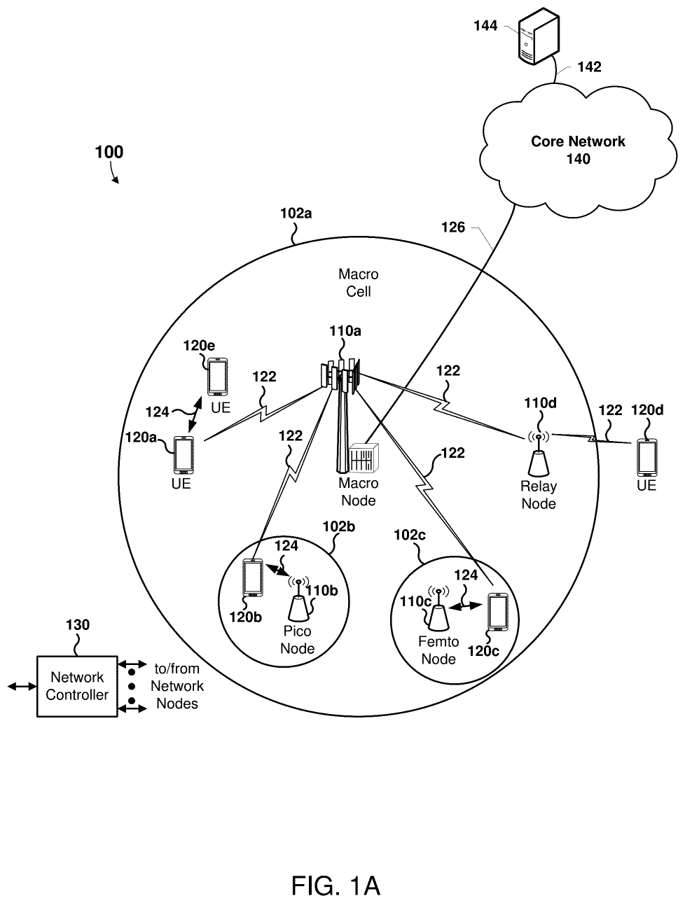

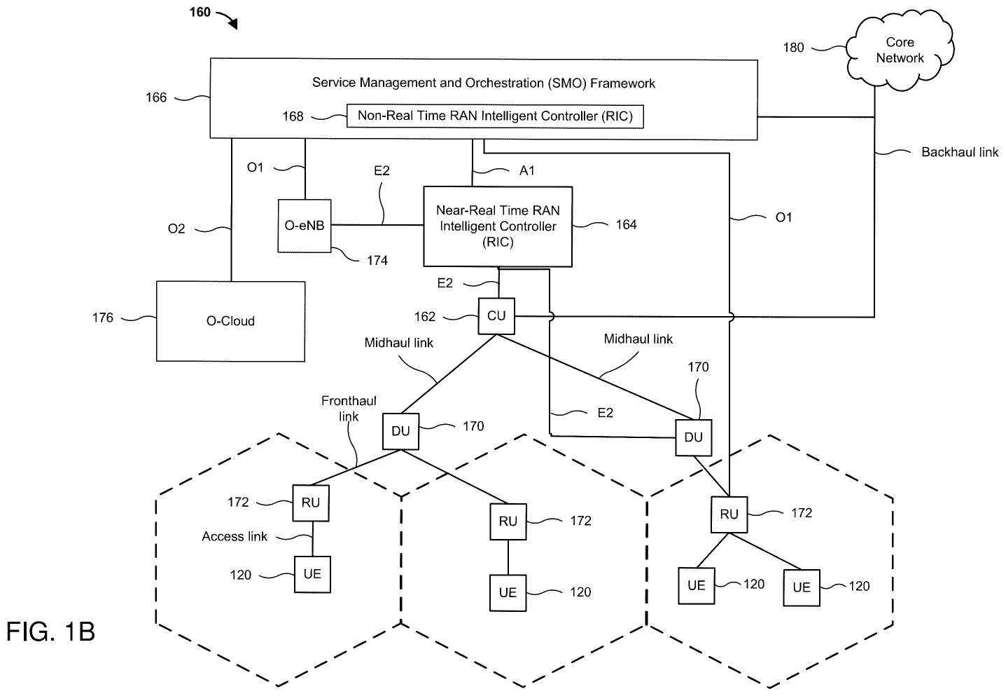

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 may include a network computing device 144, such as a server, an application server, or another suitable computing device, which may be configured to communicate with the UEs 120a-120e via a communication network (which may include communication via the core network 140) using a communication link 142. The communications system 100 also may include a number of network devices 110a, 110b, 110c, and 110d and other network entities, such as base stations and network nodes. A network device is an entity that communicates with UEs, and in various embodiments may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc.

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node for a macro cell 102a, a network device 110b may be a pico node for a pico cell 102b, and a network device 110c may be a femto node for a femto cell 102c. A network device 110a-110d may support one or multiple (for example, three) cells. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network

The network device 110a-110d may communicate with the core network 140 over a wired or wireless communication link 126. The UE 120a-120e may communicate with the network node 110a-110d over a wireless communication link 122. Wired communication links (e.g., 126, 142) may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and transmit the data to a downstream station (for example, a UE or a network device). A relay station also may be a UE that can relay transmissions for other UEs. In the example illustrated in FIG. 1A, a relay station 110d may communicate with macro the network device 110a and the UE 120d in order to facilitate communication between the network device 110a and the UE 120d. A relay station also may be referred to as a relay network device, a relay base station, a relay, etc.

The communications system 100 may be a heterogeneous network that includes network devices of different types, for example, macro network devices, pico network devices, femto network devices, relay network devices, etc. These different types of network devices may have different transmit power levels, different coverage areas, and different impacts on interference in communications system 100. For example, macro nodes may have a high transmit power level (for example, 5 to 40 Watts) whereas pico network devices, femto network devices, and relay network devices may have lower transmit power levels (for example, 0.1 to 2 Watts).

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc. A macro network device 110a may communicate with the communication network 140 over a wired or wireless communication link 126. The UEs 120a, 120b, 120c may communicate with a network device 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported. Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUS, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

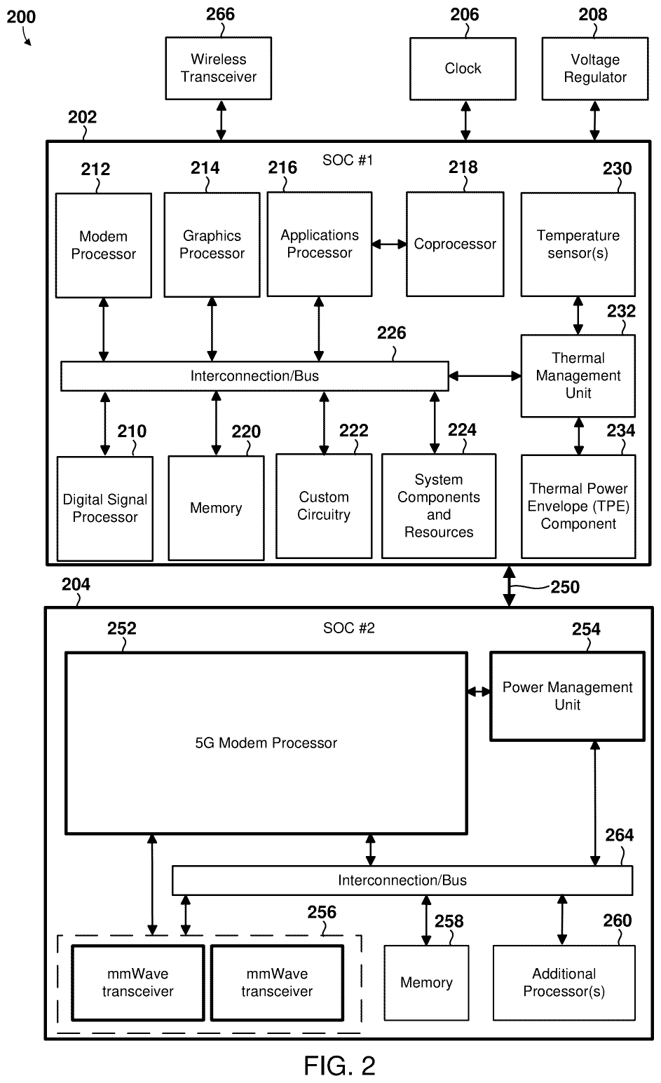

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a UE (e.g., 120a-120e) or a network device (e.g., 110a-110d). In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wavelength (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

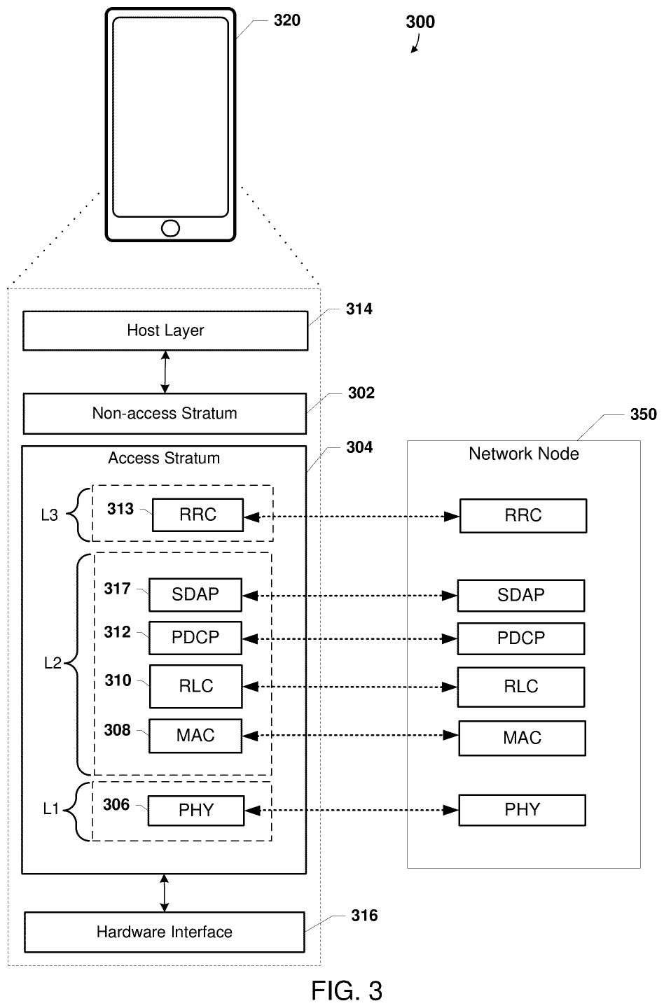

FIG. 3 is a component block diagram illustrating a software architecture 300 including a radio protocol stack for the user and control planes in wireless communications suitable for implementing any of the various embodiments. With reference to FIGS. 1A-3, the UE 320 may implement the software architecture 300 to facilitate communication between a UE 320 (e.g., the UE 120a-120e, 200) and the network device 350 (e.g., the network device 110a-110d) of a communication system (e.g., 100). In various embodiments, layers in software architecture 300 may form logical connections with corresponding layers in software of the network device 350. The software architecture 300 may be distributed among one or more processors (e.g., the processors 212, 214, 216, 218, 252, 260). While illustrated with respect to one radio protocol stack, in a UE having a multi-subscriber identity module (SIM), the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a network device, network node, RU, base station, etc.). In particular, the AS 304 may include at least three layers (Layer 1, Layer 2, and Layer 3), each of which may contain various sublayers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network node 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the network node 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the UE 320 and the network node 350.

In various embodiments, the SDAP sublayer 317 may provide mapping between Quality of Service (QOS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor (e.g., 202).

In other implementations, the software architecture 300 may include one or more higher logical layers (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

In various network implementations or architectures, in the network device 350 the different logical layers 308-317 may be implemented in an aggregated or monolithic base station architecture, or alternatively, in a disaggregated network device architecture, and various logical layers may implemented in one or more of a CU, a DU, an RU, a Near-RT RAN Intelligent Controller (RIC), or a Non-Real Time (Non-RT) RIC. Further, the network device 350 may be implemented as an aggregated base station, as a disaggregated base station, an integrated access and backhaul (IAB) node, a relay node, a sidelink node, etc.

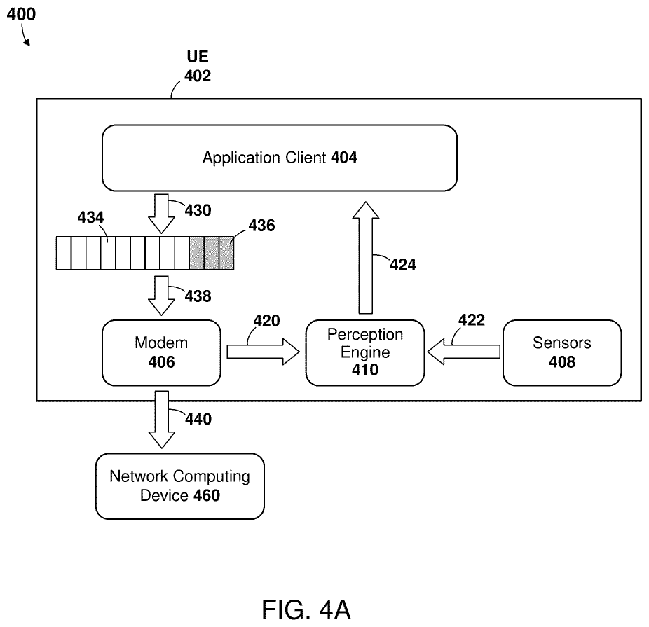

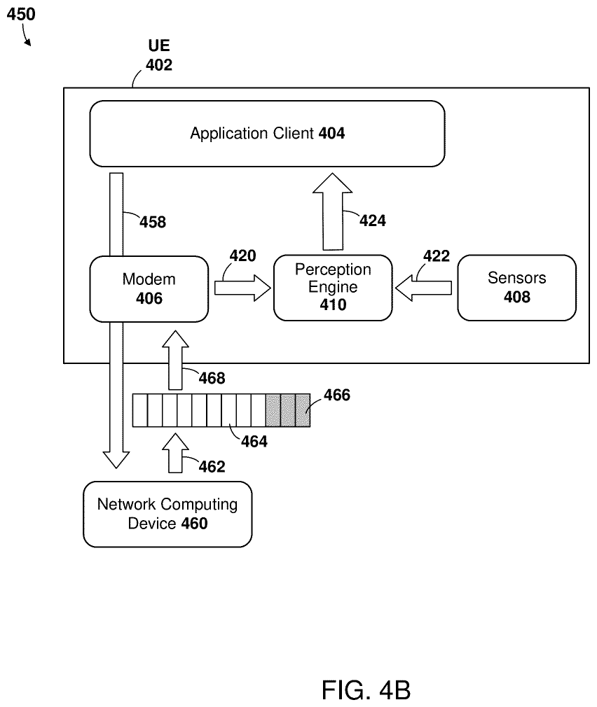

FIG. 4A is a block diagram illustrating an example system architecture 400 suitable for implementing any of the various embodiments. With reference to FIGS. 1A-4A, the system architecture 400 may include a UE 402 (e.g., 120a-120e, 200, 320) and a network computing device 460 (e.g., 144). The UE 402 may include an application client 404, a modem 406, one or more sensors 408, and a perception engine 410. In various embodiments, the system architecture 400 may enable the UE to proactively perform forward error correction in uplink transmissions based on wireless communication parameters and UE sensor information. In various embodiments, the perception engine 410 may be instantiated in hardware, software, or a combination of hardware and software.

The modem 406 may provide in operation 420 to the perception engine 410 parameters of a wireless communication link by which the UE 402 receives data transmitted from the remote computing device 460. The perception engine 410 also may receive 422 sensor information from the sensors 408 in operation 422. In some embodiments, an application executing on the UE, such as an XR application, may provide the information from the sensors 408 to the perception engine 410. In some embodiments, the sensor information may include pose information of the UE. Using the parameters of the wireless communication link and the sensor information, the perception engine 410 may predict the condition of the wireless communication link. The perception engine 410 may provide the prediction to the application client 404 in operation 424.

The application client 404 may select an FEC rate based on the prediction of the condition of the wireless communication link. In some embodiments, the application client 404 may use the selected FEC rate in data transmissions from the UE to the remote computing device. The application client 404 may apply the selected FEC rate to data transmitted by the UE. For example, the application client 404 may apply in operation 430 the selected FEC rate to include repair packets 436 with data packets 434. The application client 404 may provide in operation 438 the data packets 434 and the repair packets 436 to the modem 406 for transmission in operation 440 to the remote computing device 460.

FIG. 4B is a block diagram illustrating an example system architecture 450 suitable for implementing any of the various embodiments. With reference to FIGS. 1A-4B, the system architecture 400 may include a UE 402 (e.g., 120a-120e, 200, 320) and a network computing device 460 (e.g., 144).

In the system architecture 450, the application client 404 executing in the UE 402 may receive a prediction of the condition of the wireless communication link from the perception engine 410 as described. The application 404 may transmit a message 458 to the network computing device 460 via the modem 406. In some embodiments, the message 458 may include the prediction of the condition of the wireless communication link (i.e., over which the UE 402 receives data transmitted from the network computing device 460). In some embodiments, the message 458 may include a requested or recommended FEC rate.

In some embodiments, the network computing device 460 may receive the requested or recommended FEC rate and may apply in operation 462 the FEC rate to data transmissions from the network computing device 460 to the UE 402, adding repair packets 466 to data packets 464, and transmitting in operation 468 the data packets 464 and the repair packets 466 to the UE 402.

In some embodiments, the network computing device 460 may receive in the message 458 the prediction of the condition of the wireless communication link. In such embodiments, the network computing device 460 may select an FEC rate for the data transmissions to the UE based on the received prediction of the condition of the wireless communication link. The network computing device 460 may apply 460 to the selected FEC rate to the data transmission to the UE, adding the repair packets 466 to the data packets 464. The network computing device 460 may transmit 468 the data packets 464 and the repair packets 466 to the UE 402.

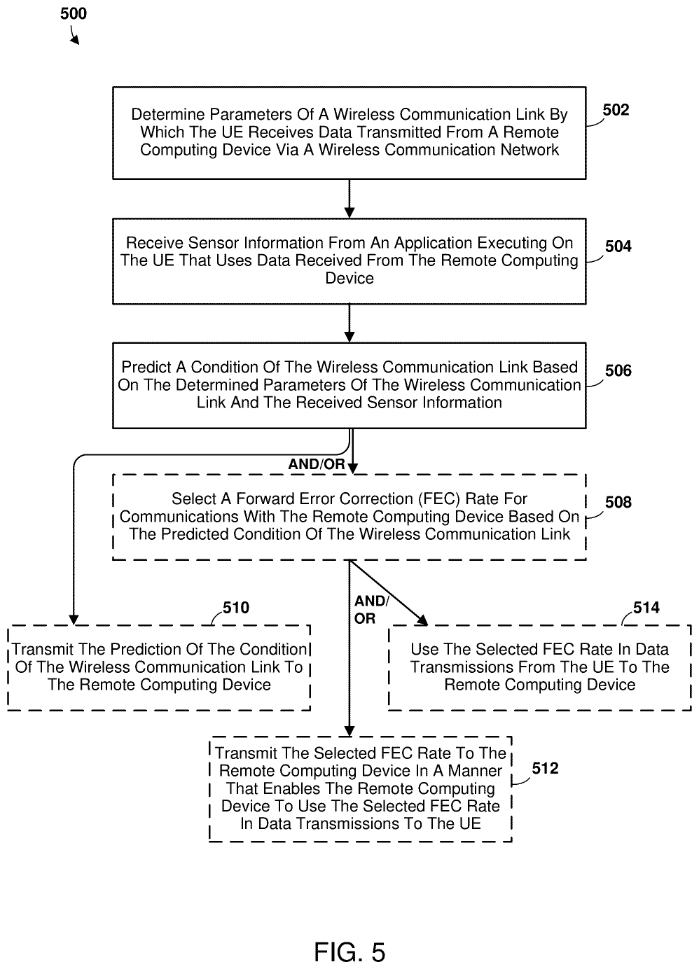

FIG. 5 is a process flow diagram illustrating a method 500 that may be performed by a processor of a UE for dynamic error correction for data transmissions in accordance with various embodiments. With reference to FIGS. 1A-5, the operations of the method 500 may be performed by a processor (such as the processor 210, 212, 214, 216, 218, 252, 260) of a UE (such as the UE 120a-120e, 200, 320, 402, 700, 900), referred to generally herein as a “processor.”

In block 502, the processor may determine parameters of a wireless communication link by which the UE receives data that is transmitted from a remote computing device (e.g., 144, 460) (e.g., via a wireless communication network) and that is used by an application executing in the UE. For example, the processor (e.g., executing the perception engine 410) may receive parameters of the wireless communication link from the modem 406. Non-limiting examples of wireless communication link parameters include link quality measurements, bit error rate, packet error rate, block error rate, signal quality, signal-to-noise ratio, and the like.

In block 504, the processor may receive sensor information from sensors of the UE. For example, the processor may receive sensor information from position, movement and/or orientation (i.e., pose-related) sensors on the UE that is executing an application using data received from the remote computing device. In some embodiments, the processor may receive pose information from a sensor of an XR device. For example, the processor (e.g., executing the perception engine 410) may receive sensor information from sensors 408 via an application (e.g., an XR application) executing on the UE. Examples of pose-related sensors from which the processor may receive information in block 504 include accelerometers (e.g., 3-axis accelerometers), gyroscopes (e.g., 3-axis gyroscopes), gravitometers (i.e., accelerometers configured to sense the gravity vector), GPS receiver, radio frequency (RF) based position sensors, and the like. The processor also may receive sensor information from other types of sensor, including for example inertial motion sensors, as well as cameras and lidar that can be used to generate a depth map or other information providing distance(s) and directions to object surfaces from the UE.

In block 506, the processor may predict a condition of the wireless communication link based on the determined parameters of the wireless communication link and the received sensor information. In some embodiments, the processor may predict a change in RF conditions based on the determined parameters of the wireless communication link and the received sensor information. In some embodiments, the processor may predict a block error rate (BLER) of data received from the remote computing device. In some embodiments, the processor may predict a transport Block (TB) size of data received from the remote computing device. In some embodiment, the processor may predict a change in RF attenuating conditions that may decrease or increase aspects or parameters of the wireless communication link.

In some embodiments, in optional block 510, the UE may transmit the prediction of the condition of the wireless communication link to the remote computing device. In some embodiments, the remote computing device may use the prediction of the condition of the wireless communication link to select an FEC rate for communications with the UE, as further described below.

Additionally or alternatively, in optional block 508, the processor may select an FEC rate for communications with the remote computing device based on the predicted condition of the wireless communication link. For example, the application client 404 may select the FEC rate for the wireless communication link by which the UE 402 receives communications from, and transmits communications to, the remote computing device 460.

After selecting the FEC rate for communications with the remote communication device, in optional block 512, the processor may transmit the selected FEC rate (e.g., in a message) to the remote computing device in a manner that enables the remote computing device to use the selected FEC rate and data transmissions to UE. For example, the UE 402 may transmit the selected FEC rate to the remote computing device 460.

Additionally or alternatively, in optional block 514, the processor may use the selected FEC rate in data transmissions from the UE to the remote computing device. For example, the UE 402 may apply the selected FEC rate to transmissions of the data packets 434 from the UE 402 to the network computing device 460.

The operations in the method 500 may be performed continuously, periodically or episodically to adjust the FEC rate in response to further changes in position and pose of the UE.

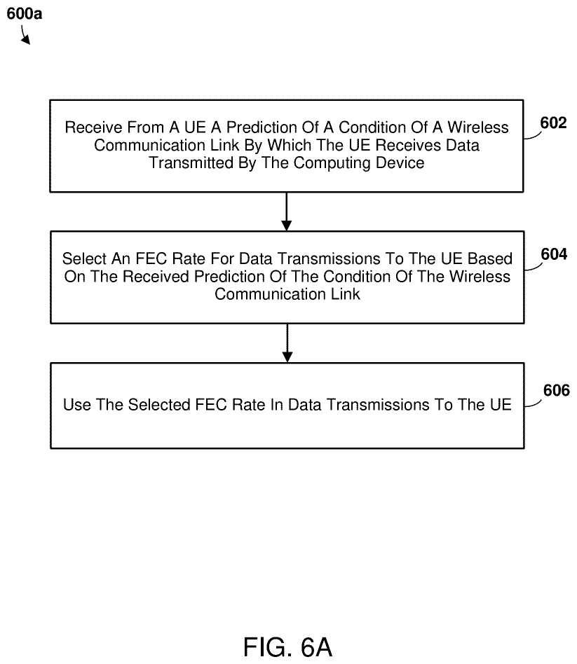

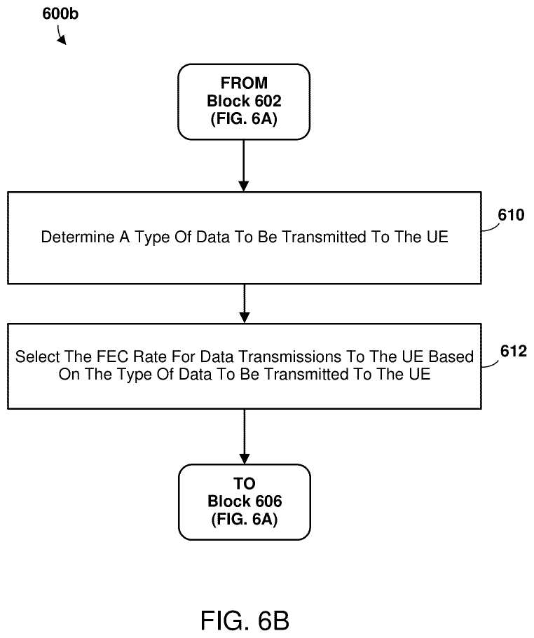

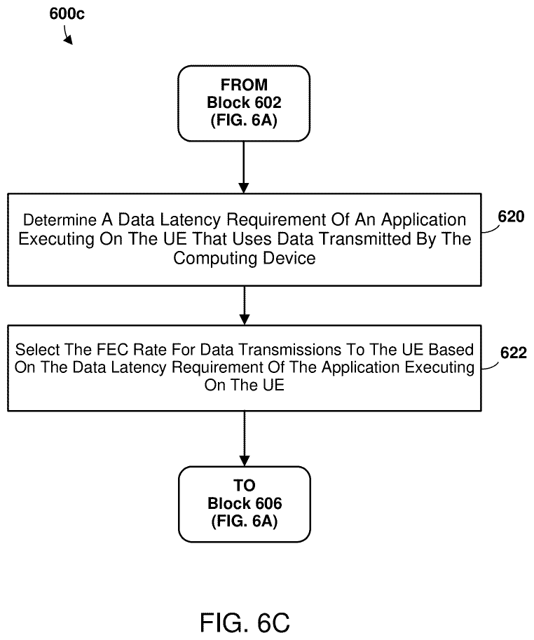

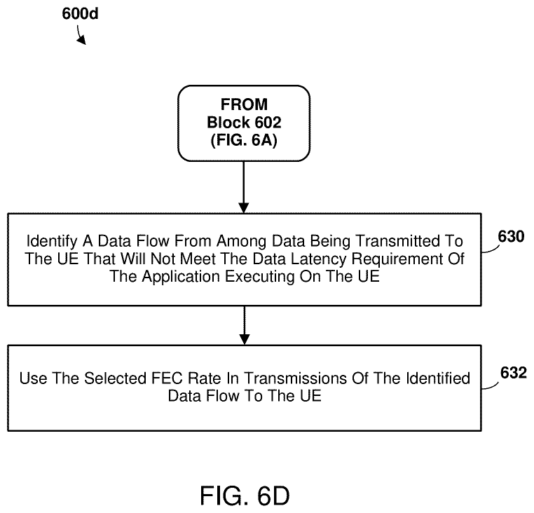

FIG. 6A is a process flow diagram illustrating a method 600a that may be performed by a processor of a computing device for dynamic error correction for data transmissions in accordance with various embodiments. With reference to FIGS. 1A-6A, the operations of the method 600a may be performed by a processor (such as the processor 210, 212, 214, 216, 218, 252, 260) of a computing device (such as the computing device 144, 460), referred to generally herein as a “processor.”

In block 602, the processor may receive from a UE (e.g., 120a-120e, 200, 320, 402, 700, 900) a prediction of a condition of a wireless communication link by which the UE receives data transmitted by the computing device. For example, the network computing device 460 may receive from the UE 402 a prediction of the condition of the wireless communication link. In some embodiments, the processor may receive a prediction of UE pose information from the UE.

In block 604, the processor may select an FEC rate for data transmissions to the UE based on the received prediction of the condition of the wireless communication link. For example, the network computing device 460 may select the FEC rate for transmission of data packets 464 to the UE 402. In some embodiments, the processor may select the FEC rate based on the prediction of the UE pose information.

In block 606, the processor may use the selected FEC rate in data transmissions to the UE. For example, the network computing device 460 may apply the selected FEC rate to the transmission of the data packets 464 to the UE 402.

The operations in the method 600a may be performed continuously, periodically or episodically to adjust the FEC rate in response to further changes in position and pose of the UE.

FIGS. 6B-6D are process flow diagrams illustrating operations 600b-600d that may be performed by a processor of a computing device as part of the method 600a for dynamic error correction for data transmissions in accordance with various embodiments. With reference to FIGS. 1A-6D, the operations 600b-600d may be performed by a processor (such as the processor 210, 212, 214, 216, 218, 252, 260) of a computing device (such as the computing device 144, 460), referred to generally herein as a “processor.”

Referring to FIG. 6B, in operations 600b, after receiving from a UE a prediction of a condition of a wireless communication link by which the UE receives data transmitted by the computing device in block 602 as described, the processor may determine a type of data to be transmitted to the UE in block 610. For example, the UE may determine whether data to be transmitted to the UE includes audio data, image data, video data, multimedia data, and/or the like.

In block 612, the processor may select the FEC rate for data transmissions to the UE based on (or further based on, in addition to other criteria) the type of data to be transmitted to the UE.

The processor may use the selected FEC rate in data transmissions to the UE in block 606 as described.

Referring to FIG. 6C, in operations 600c, after receiving from a UE a prediction of a condition of a wireless communication link by which the UE receives data transmitted by the computing device in block 602 as described, the processor may determine a data latency requirement of an application (such as an XR application) executing on the UE that uses data transmitted by the computing device in block 620.

In block 622, the processor may select the FEC rate for data transmissions to the UE based on (or further based on, in addition to other criteria) the data latency requirement of the application executing on the UE.

The processor may use the selected FEC rate in data transmissions to the UE in block 606 as described.

Referring to FIG. 6D, in operations 600d, after receiving from a UE a prediction of a condition of a wireless communication link by which the UE receives data transmitted by the computing device in block 602 as described, the processor may identify a data flow from among data being transmitted to the UE that will not meet the data latency requirement of the application executing on the UE in block 630.

In block 632, the processor may use the selected FEC rate in transmissions of the identified data flow to the UE. In some embodiments, the network computing device may selectively apply an FEC rate to one or more data flows from among the data being transmitted to the UE. For example, the network computing device may identify a data flow that will not meet a data latency requirement of the application executing on the UE. In such embodiments, the network computing device may use the selected FEC rate for the identified data flow. In such embodiments, the network computing device may not apply the selected FEC data rate to one or more other data flows transmitted to the UE. In some embodiments, the network computing device may apply the selected FEC data rate to only the identified data flow, but not to any (or all) other data being transmitted to the UE.

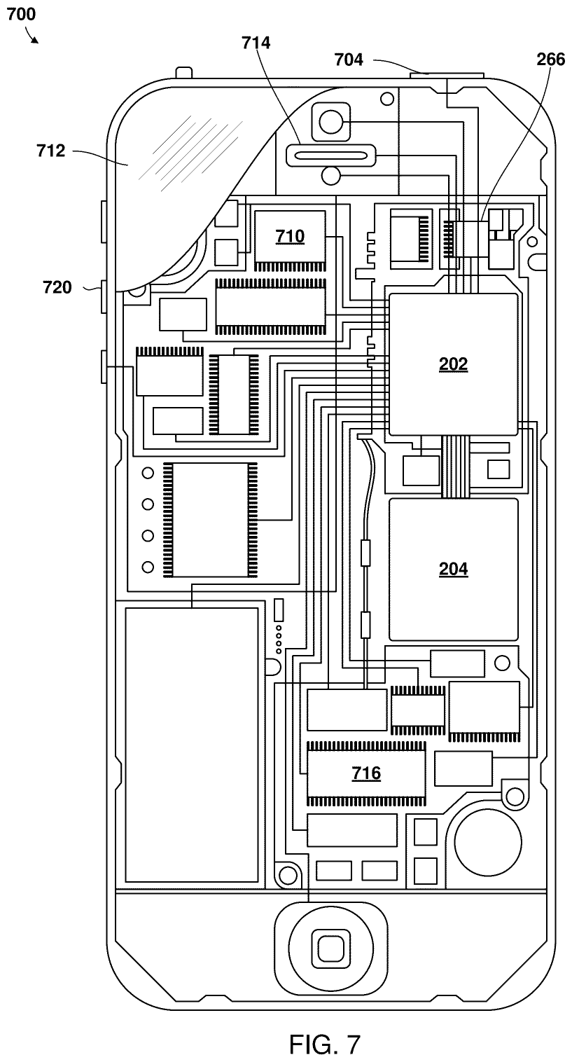

FIG. 7 is a component block diagram of a UE 700 suitable for use with various embodiments. With reference to FIGS. 1A-7, various embodiments may be implemented on a variety of UEs 700 (for example, the UEs 120a-120e, 200, 320, 402), an example of which is illustrated in FIG. 7 in the form of a smartphone. The UE 700 may include a first SOC 202 (for example, a SOC-CPU) coupled to a second SOC 204 (for example, a 5G capable SOC). The first and second SOCs 202, 204 may be coupled to internal memory 716, a display 712, and to a speaker 714. Additionally, the UE 700 may include an antenna 704 for sending and receiving electromagnetic radiation that may be connected to a wireless transceiver 266 coupled to one or more processors in the first and/or second SOCs 202, 204. The UE 700 may include menu selection buttons or rocker switches 720 for receiving user inputs. The UE 700 may include a sound encoding/decoding (CODEC) circuit 710, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 710 may include a digital signal processor (DSP) circuit (not shown separately).

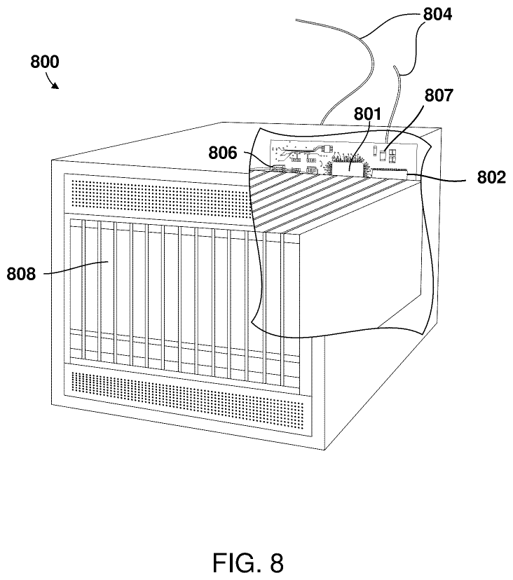

FIG. 8 is a component block diagram of a network device suitable for use with various embodiments. Such network devices (e.g., network device 110a-110d, 144, 350, 460) may include at least the components illustrated in FIG. 8. With reference to FIGS. 1A-8, the network device 800 may typically include a processor 801 coupled to volatile memory 802 and a large capacity nonvolatile memory, such as a disk drive 808. The network device 800 also may include a peripheral memory access device 806 such as a floppy disc drive, compact disc (CD) or digital video disc (DVD) drive coupled to the processor 801. The network device 800 also may include network access ports 804 (or interfaces) coupled to the processor 801 for establishing data connections with a network, such as the Internet or a local area network coupled to other system computers and servers. The network device 800 may include one or more antennas 807 for sending and receiving electromagnetic radiation that may be connected to a wireless communication link. The network device 800 may include additional access ports, such as USB, Firewire, Thunderbolt, and the like for coupling to peripherals, external memory, or other devices.

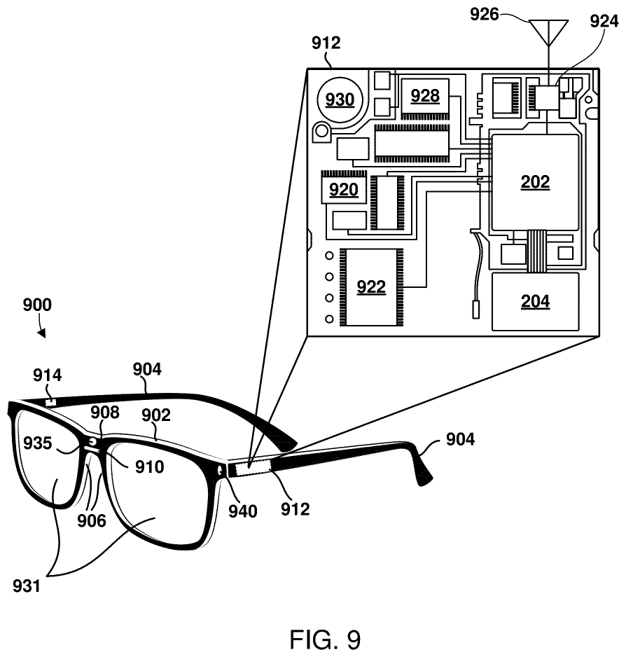

FIG. 9 is a component block diagram of a UE suitable for use with various embodiments. With reference to FIGS. 1A-9, various embodiments may be implemented on a variety of UEs, an example of which is illustrated in FIG. 9 in the form of smart glasses 900. The smart glasses 900 may operate like conventional eye glasses, but with enhanced computer features and sensors, like a built-in camera 935 and heads-up display or XR features on or near the lenses 931. Like any glasses, smart glasses 900 may include a frame 902 coupled to temples 904 that fit alongside the head and behind the ears of a wearer. The frame 902 holds the lenses 931 in place before the wearer's eyes when nose pads 906 on the bridge 908 rest on the wearer's nose.

In some embodiments, smart glasses 900 may include an image rendering device 914 (e.g., an image projector), which may be embedded in one or both temples 904 of the frame 902 and configured to project images onto the optical lenses 931. In some embodiments, the image rendering device 914 may include a light-emitting diode (LED) module, a light tunnel, a homogenizing lens, an optical display, a fold mirror, or other components well known projectors or head-mounted displays. In some embodiments (e.g., those in which the image rendering device 914 is not included or used), the optical lenses 931 may be, or may include, see-through or partially see-through electronic displays. In some embodiments, the optical lenses 931 include image-producing elements, such as see-through Organic Light-Emitting Diode (OLED) display elements or liquid crystal on silicon (LCOS) display elements. In some embodiments, the optical lenses 931 may include independent left-eye and right-eye display elements. In some embodiments, the optical lenses 931 may include or operate as a light guide for delivering light from the display elements to the eyes of a wearer.

The smart glasses 900 may include a number of external sensors that may be configured to obtain information about wearer actions and external conditions that may be useful for sensing images, sounds, muscle motions and other phenomenon that may be useful for detecting when the wearer is interacting with a virtual user interface as described. In some embodiments, smart glasses 900 may include a camera 935 configured to image objects in front of the wearer in still images or a video stream. Additionally, the smart glasses 900 may include a lidar sensor 940 or other ranging device. In some embodiments, the smart glasses 900 may include a microphone 910 positioned and configured to record sounds in the vicinity of the wearer. In some embodiments, multiple microphones may be positioned in different locations on the frame 902, such as on a distal end of the temples 904 near the jaw, to record sounds made when a user taps a selecting object on a hand, and the like. In some embodiments, smart glasses 900 may include pressure sensors, such on the nose pads 906, configured to sense facial movements for calibrating distance measurements. In some embodiments, smart glasses 900 may include other sensors (e.g., a thermometer, heart rate monitor, body temperature sensor, pulse oximeter, etc.) for collecting information pertaining to environment and/or user conditions that may be useful for recognizing an interaction by a user with a virtual user interface

The smart glasses 900 may include a processing system 912 that includes processing and communication SOCs 202, 204 which may include one or more processors (e.g., 212, 214, 216, 218, 260) one or more of which may be configured with processor-executable instructions to perform operations of various embodiments. The processing and communications SOCs 202, 204 may be coupled to internal sensors 920, internal memory 922, and communication circuitry 924 coupled one or more antenna 926 for establishing a wireless data link. The processing and communication SOCs 202, 204 may also be coupled to sensor interface circuitry 928 configured to control and receive data from a camera 935, microphone(s) 910, and other sensors positioned on the frame 902.

The internal sensors 920 may include an inertial measurement unit (IMU) that includes electronic gyroscopes, accelerometers, and a magnetic compass configured to measure movements and orientation of the wearer's head. The internal sensors 920 may further include a magnetometer, an altimeter, an odometer, and an atmospheric pressure sensor, as well as other sensors useful for determining the orientation and motions of the smart glasses 900. The processing system 912 may further include a power source such as a rechargeable battery 930 coupled to the SOCs 202, 204 as well as the external sensors on the frame 902.

The processors of the UE 700 and 900 and the network device 800 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 716, 808, 922 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations 500 and 600a-600d disclosed herein may be substituted for or combined with one or more operations of the methods and operations 500 and 600a-600d disclosed herein.

Implementation examples are described in the following paragraphs. While some of the following implementation examples are described in terms of example methods, further example implementations may include: the example methods discussed in the following paragraphs implemented by a UE or a computing device (e.g., a remote or network computing device) including a processor configured with processor-executable instructions to perform operations of the methods of the following implementation examples; the example methods discussed in the following paragraphs implemented by a UE or a computing device including means for performing functions of the methods of the following implementation examples; and the example methods discussed in the following paragraphs may be implemented as a non-transitory processor-readable storage medium having stored thereon processor-executable instructions configured to cause a processor of a UE or a computing device to perform the operations of the methods of the following implementation examples.

Example 1. A method performed by a processor of a UE for dynamic error correction for data transmissions, including: determining parameters of a wireless communication link by which the UE receives data that is transmitted from a remote computing device via a wireless communication network and that is used by an application executing in the UE; receiving sensor information from sensors of the UE; predicting a condition of the wireless communication link based on the determined parameters of the wireless communication link and the received sensor information; and selecting a FEC rate for communications with the remote computing device based on the predicted condition of the wireless communication link.

Example 2. The method of example 1, in which receiving sensor information from the application executing on the UE includes receiving pose information from a sensor of an XR device.

Example 3. The method of example 2, in which predicting the condition of the wireless communication link based on the determined parameters of the wireless communication link and the received sensor information includes predicting a change in RF conditions based on the determined parameters of the wireless communication link and the received sensor information.

Example 4. The method of any of examples 1-3, further including transmitting the selected FEC rate to the remote computing device in a manner that enables the remote computing device to use the selected FEC rate in data transmissions to the UE.

Example 5. The method of any of examples 1-4, further including using the selected FEC rate in data transmissions from the UE to the remote computing device.

Example 6. The method of any of examples 1-5, in which predicting the condition of the wireless communication link includes predicting a BLER of data received from the remote computing device.

Example 7. The method of any of examples 1-6, in which predicting the condition of the wireless communication link includes predicting a TB size of data received from the remote computing device.

Example 8. A method performed by a processor of a computing device for dynamic error correction for data transmissions, including: receiving from a UE a prediction of a condition of a wireless communication link by which the UE receives data transmitted by the computing device; selecting a FEC rate for data transmissions to the UE based on the received prediction of the condition of the wireless communication link; and using the selected FEC rate in data transmissions to the UE.

Example 9. The method of example 8, in which: receiving from the UE the prediction of the condition of the wireless communication link by which the UE receives data transmitted by the computing device includes receiving a prediction of UE pose information; and selecting the FEC rate for data transmissions to the UE based on the received prediction of the condition of the wireless communication link includes selecting the FEC rate based on the prediction of UE pose information.

Example 10. The method of either of examples 8 or 9, further including determining a type of data to be transmitted to the UE, in which selecting the FEC rate for data transmissions to the UE is further based on the type of data to be transmitted to the UE.

Example 11. The method of any of examples 8-10, further including determining a data latency requirement of an application executing on the UE that uses data transmitted by the computing device, in which selecting the FEC rate for data transmissions to the UE is further based on the data latency requirement of the application executing on the UE.

Example 12. The method of any of examples 8-11, further including identifying a data flow from among data being transmitted to the UE that will not meet a data latency requirement of the application executing on the UE, in which using the selected FEC rate in data transmissions to the UE comprises using the selected FEC rate in transmissions of the identified data flow to the UE.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running in a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of a user equipment (UE) for dynamic error correction for data transmissions, comprising:
determining parameters of a wireless communication link by which the UE receives data that is transmitted from a remote computing device via a wireless communication network and that is used by an application executing in the UE;
receiving sensor information from sensors of the UE;
predicting a condition of the wireless communication link based on the determined parameters of the wireless communication link and the received sensor information; and
selecting a forward error correction (FEC) rate for communications with the remote computing device based on the predicted condition of the wireless communication link.

2. The method of claim 1, wherein receiving sensor information from the application executing on the UE comprises receiving pose information from a sensor of an extended reality (XR) device.

3. The method of claim 2, wherein predicting the condition of the wireless communication link based on the determined parameters of the wireless communication link and the received sensor information comprises predicting a change in radio frequency (RF) conditions based on the determined parameters of the wireless communication link and the received sensor information.

4. The method of claim 1, further comprising:
transmitting the selected FEC rate to the remote computing device in a manner that enables the remote computing device to use the selected FEC rate in data transmissions to the UE.

5. The method of claim 1, further comprising:
using the selected FEC rate in data transmissions from the UE to the remote computing device.

6. The method of claim 1, wherein predicting the condition of the wireless communication link comprises predicting a block error rate (BLER) of data received from the remote computing device.

7. The method of claim 1, wherein predicting the condition of the wireless communication link comprises predicting a transport block (TB) size of data received from the remote computing device.

8. A user equipment (UE), comprising:
a processor configured with processor-executable instructions to:
determine parameters of a wireless communication link by which the UE receives data that is transmitted from a remote computing device via a wireless communication network and that is used by an application executing in the UE;
receive sensor information from sensors of the UE;
predict a condition of the wireless communication link based on the determined parameters of the wireless communication link and the received sensor information; and
select a forward error correction (FEC) rate for communications with the remote computing device based on the predicted condition of the wireless communication link.

9. The UE of claim 8, wherein the processor is further configured with processor-executable instructions to receive pose information from a sensor of an extended reality (XR) device.

10. The UE of claim 9, wherein the processor is further configured with processor-executable instructions to predict a change in radio frequency (RF) conditions based on the determined parameters of the wireless communication link and the received sensor information.

11. The UE of claim 8, wherein the processor is further configured with processor-executable instructions to:
transmit the selected FEC rate to the remote computing device in a manner that enables the remote computing device to use the selected FEC rate in data transmissions to the UE.

12. The UE of claim 8, wherein the processor is further configured with processor-executable instructions to:
use the selected FEC rate in data transmissions from the UE to the remote computing device.

13. The UE of claim 8, wherein the processor is further configured with processor-executable instructions to predict a block error rate (BLER) of data received from the remote computing device.

14. The UE of claim 8, wherein the processor is further configured with processor-executable instructions to predict a transport block (TB) size of data received from the remote computing device.

15. A method performed by a processor of a computing device for dynamic error correction for data transmissions, comprising:
receiving from a user equipment (UE) a prediction of a condition of a wireless communication link by which the UE receives data transmitted by the computing device;
selecting a forward error correction (FEC) rate for data transmissions to the UE based on the received prediction of the condition of the wireless communication link; and
using the selected FEC rate in data transmissions to the UE.

16. The method of claim 15, wherein
receiving from the UE the prediction of the condition of the wireless communication link by which the UE receives data transmitted by the computing device comprises receiving a prediction of UE pose information, and
selecting the FEC rate for data transmissions to the UE based on the received prediction of the condition of the wireless communication link comprises selecting the FEC rate based on the prediction of UE pose information.

17. The method of claim 15, further comprising:
determining a type of data to be transmitted to the UE,
wherein selecting the FEC rate for data transmissions to the UE is further based on the type of data to be transmitted to the UE.

18. The method of claim 15, further comprising:
determining a data latency requirement of an application executing on the UE that uses data transmitted by the computing device,
wherein selecting the FEC rate for data transmissions to the UE is further based on the data latency requirement of the application executing on the UE.

19. The method of claim 15, further comprising:
identifying a data flow from among data being transmitted to the UE that will not meet a data latency requirement of an application executing on the UE,
wherein using the selected FEC rate in data transmissions to the UE comprises using the selected FEC rate in transmissions of the identified data flow to the UE.

20. A computing device, comprising:
a processor configured with processor-executable instructions to:
receive from a user equipment (UE) a prediction of a condition of a wireless communication link by which the UE receives data transmitted by the computing device;
select a forward error correction (FEC) rate for data transmissions to the UE based on the received prediction of the condition of the wireless communication link; and
use the selected FEC rate in data transmissions to the UE.

21. The computing device of claim 20, wherein the processor is further configured with processor-executable instructions to:
receive a prediction of UE pose information, and
select the FEC rate based on the prediction of UE pose information.

22. The computing device of claim 20, wherein the processor is further configured with processor-executable instructions to:
determine a type of data to be transmitted to the UE; and
select the FEC rate for data transmissions to the UE based on the type of data to be transmitted to the UE.

23. The computing device of claim 20, wherein the processor is further configured with processor-executable instructions to:
determine a data latency requirement of an application executing on the UE that uses data transmitted by the computing device; and
select the FEC rate for data transmissions to the UE based on the data latency requirement of the application executing on the UE.

24. The computing device of claim 20, wherein the processor is further configured with processor-executable instructions to:
identify a data flow from among data being transmitted to the UE that will not meet a data latency requirement of an application executing on the UE; and
use the selected FEC rate in transmissions of the identified data flow to the UE.
